(19) United States
(12) Patent Application Publication
(10) Pub. No.: US 2010/0320721 A1
(43) Pub. Date: Dec. 23, 2010

(54) TUBE SEAT WITH A FRAME STRUCTURE FOR A BICYCLE

(76) Inventor: CHING-CHI CHUNG, Pingtung County (TW)

Correspondence Address: G. LINK CO., LTD., 3550 BELL ROAD, MINOOKA, IL, 60447, US

(21) Appl. No.: 12/486,442

(22) Filed: Jun. 17, 2009

(51) Int. Cl. B62K 3/04

(52) U.S. Cl. 280/281.1

(57) ABSTRACT

A tube seat, which is made of titanium alloy, for fabricating a frame of a bicycle include a main tube and at least a branch tube extending outward from said main tube. The branch tube is arc-welded with a metal tube made of titanium alloy firmly. The tube seat is fabricated as an upper tube seat, a five-way tube seat, a head tube seat, a hook tube seat, a crank arm seat, and a fork seat. The metal tube is fabricated as seat tube, a top tube, a seat stay, a down tube, a chain stay, a crank arm, and a fork for forming the frame.

### BACKGROUND OF THE INVENTION

1. Field of the Invention

The present invention is related to a frame structure for a bicycle and particularly to a frame structure, which contains multiple preformed tube seats being welded with metal tubes.

2. Brief Description of the Related Art

The bicycle has been developed as a movable apparatus with complex functions for leisure and sports in addition to being the traditional transportation tool. The government has built many bicycle lanes and bicycle competition fields to comply with more and more people loving to use the bicycle. There are a variety of bicycles being designed with different functions for meeting different needs. In addition, better materials have been developed to enforce the strength of the bicycle and to reduce the weight of the bicycle. Conventionally, the frame of the bicycle is an important part of the bicycle for being subjected to the weight of the rider and engaging with other parts of the bicycle for the bicycle being capable of running well. Hence, the structure and strength of the frame influence effectiveness of the bicycle significantly. Good structural and strength arrangements are able to diverse the impacts coming from the bicycle riding and increase the stability of the moving bicycle. Referring to FIGS. 1 and 2, the traditional frame 10 provides a seat tube 11 with the upper end thereof being welded to an end of the top tube 12 and the seat stay 13 and the lower end thereof being welded to the five-way tube 14 respectively. Then, the five-way tube 14 is welded to an end of the down tube 15 and the chain stay 16 respectively. Further, the other end of the top tube 12 and the other end of the down tube 15 are welded to the head tube 17 to constitute the frame 10. The conventional frame 10 has the following deficiencies:

1. It is hard to work: The seat tube 11, the top tube 12, the seat stay 13, the five-way tube 14, the down tube 15, the chain stay 16 and the head tube 17 are welded together with specific inclinations. It has to be figured out the angular positions of the preceding tubes accurately in order to avoid the mistaken angular positions and it creates many difficulties at the time of the work of welding being performed.

2. It has an unfavorable structure: The fillet weld being applied between two of the preceding tubes, especially the five-way tube 14 being welded to the seat tube 11, the down tube 15 and the chain stay 16, is easy to be welded repeatedly at the binding junction and create the stress concentration at the welded spot with undesirable strength and brittleness. Furthermore, the same spot with repeated high temperature welding is liable to deform the material and the work of correction has to done after the process of welding to complicate the fabrication of the frame.

3. It is inferior in appearance: There are weld seams at the binding junctions of fabricated frame, and the coarse weld seams are impossible to be finished with the grinder especially at the curved surfaces or narrow corners. As a result, the coarse weld seams are still there even after the frame is fabricated completely to affect the outer looks thereof.

Besides, in order to obtain the frame 10 with a high quality, titanium or titanium alloy is used as the material of the frame. Titanium has the mechanical properties such as lightness in weight and high strength. However, welding two work pieces made with titanium or titanium alloy needs more strict requirements for considering the issues relating to the property of shape memory and protection of the idle gas. Hence, fabricating the frame made with titanium or titanium alloy is more difficult than made with the conventional material.

### SUMMARY OF THE INVENTION

In order to improve the preceding deficiencies of the conventional frame of the bicycle, a tube seat according to the present invention is preformed based on the different required shapes to be welded to the metal tubes before the frame is fabricated.

Accordingly, an object of the present invention is to provide a tube seat structure, which is a short tube with at least a branch tube to be butt-joined to the elongated metal tube made of titanium alloy firmly with the arc welding. Thus, the frame can be formed with different tube seats being welded with different metal tubes conveniently.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a perspective view of the conventional frame for a bicycle;

FIG. 2 is a fragmentary perspective view of the conventional frame for a bicycle illustrating the five-way tube being welded;

FIG. 3 is a perspective view illustrating a tube seat for fabricating a frame of a bicycle according to the present invention;

FIG. 4 is a plan view of a frame for a bicycle according to the present invention;

FIG. 5 is a plan view illustrating the tube seat shown in FIG. 3 being welded with the down tube of the frame;

FIG. 6 is a plan view similar to FIG. 4 illustrating the frame of the invention after the welding process;

FIG. 7 is a perspective view of a crank arm according to the present invention; and

FIG. 8 is a perspective view of a front fork according to the present invention.

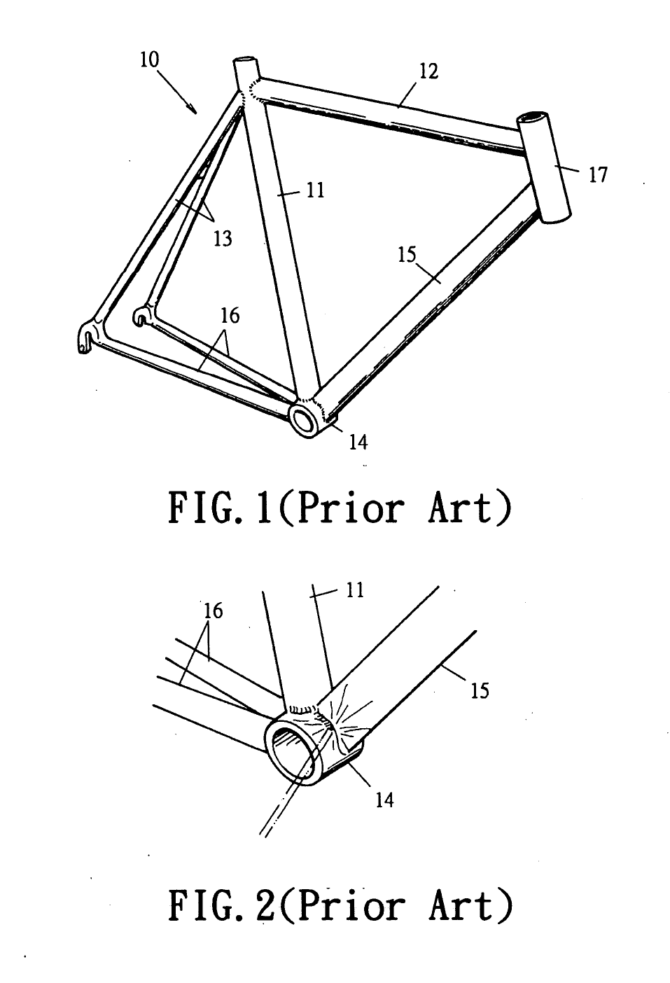

### DETAILED DESCRIPTION OF THE INVENTION

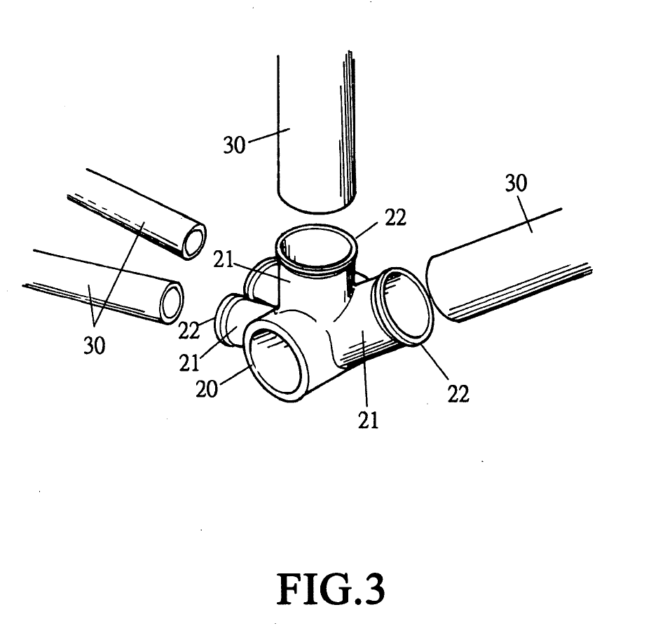

Referring to FIG. 3, a tube seat 20 according to the present invention is illustrated. The tube seat 20 is made of Titanium alloy and integrally fabricated with casting, forging or the like. The tube seat 20 has four branch tubes 21 and at the outer end of each branch tube 21 projects outward a stuffing ring 22 radially. It is noted that the tube seat 20 is integrally made with the branch tubes 21 as a single unit. Each of the branch tubes 21 is employed to butt-join a tube 30 made of Titanium alloy and the arc welding is applied to weld the tube 30 to the corresponding branch tube 21 and the tube 30 is secured to the tube seat 20 firmly. The stuffing ring 22 at the outer end of the respective branch tube 21 fills with the molten recesses, which results from the work of the arc welding, between the respective branch tube 21 and the tube 30. Under this circumference, the weld seam between the respective branch tube 21 and the tube 30 keeps a smooth surface after the process of arc welding is finished.

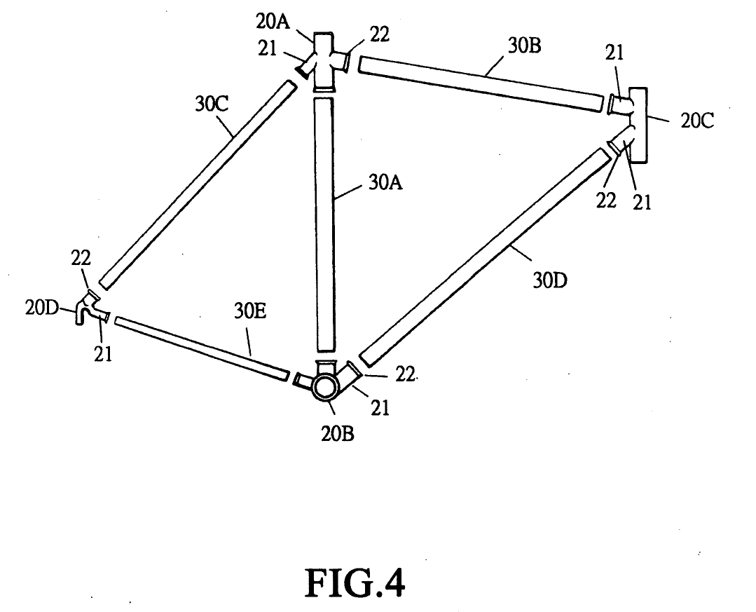

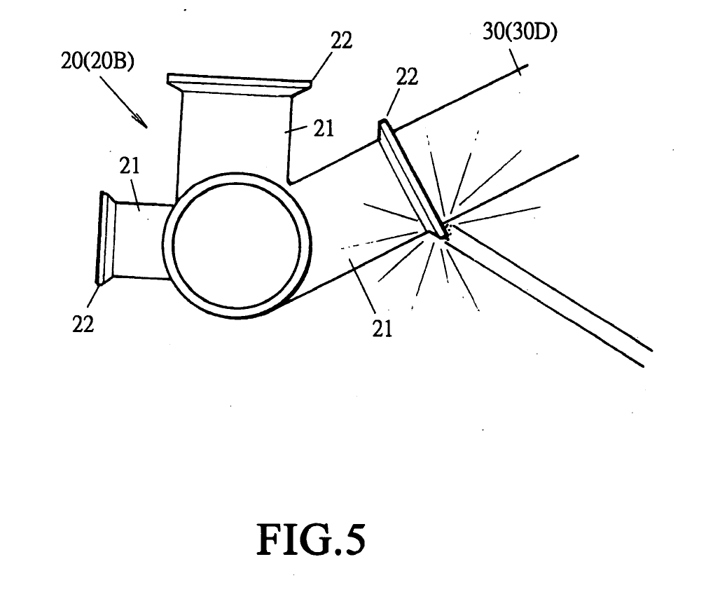

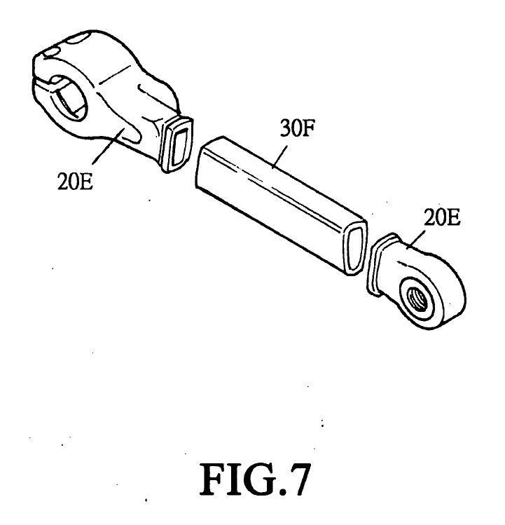

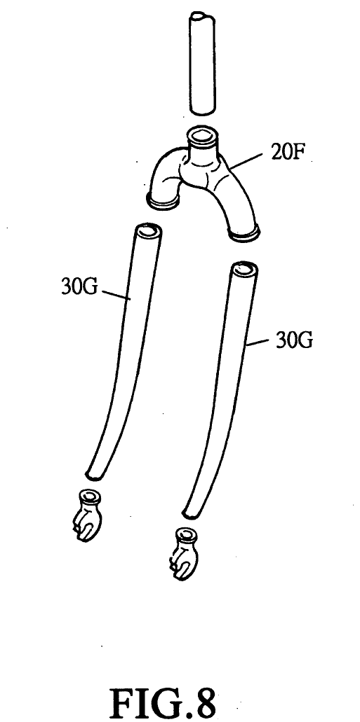

The tube seat 20 can be implemented as an upper tube seat 20A, a five-way tube seat 20B, a head tube seat 20C and a hook tube seat 20D as shown in FIGS. 4 and 5. Further, the tube seat 20 can be implemented as a crank arm seat 20E and a fork seat 20F as shown in FIGS. 7 and 8. The metal tube 30 is implemented as the seat tube 30A, the top tube 30B, the two seat stay tubes 30C, the down tube 30D, the chain stay tube 30E, the crank arm tube 30F and the two fork tubes 30G. An end of the seat tube 30A is butt-welded to the upper tube seat 20A and the other end of the seat tube 30A is butt-welded to a branch tube 21 of the five-way tube seat 20B. An end of the top tube 30B is butt-welded to another branch tube 21 of the upper tube seat 20A and the other end of the top tube 30B is butt-welded to a branch tube 21 of the head tube seat 20C. An end of the down tube 30D is butt-welded to another branch tube 21 of the five-way tube seat 20B and the other end of the down tube 30D is butt-welded to another branch tube 21 of the heat tube seat 20C. An end of the seat stay tube 30C is butt-welded to a further branch tube 21 of the vertical tube 20A and the other end of the seat stay tube 30C is butt-welded to the hook tube seat 20D. An end of the chain stay tube 30E is butt-welded to a further branch tube 21 of the five-way tube 20B and the other end of the chain stay tube 30E is butt-welded to a branch tube 21 of the hook tube seat 20D. Both ends of the crank arm tube 30F are butt-welded to a crank arm seat 20E respectively. An end of the respective fork tube 30G is butt-welded to the fork seat 20F. As the foregoing, the branch tubes 21 of the tube seat is attached to the metal tubes 30 with the arc welding, and the stuffing ring 22 at the outer end of the respective branch tube 21 compensates the molten recesses resulting from the arc welding. In this way, the branch tubes 21 and the metal tubes 30 are bound to each other thoroughly and the welded joints form smooth surfaces.

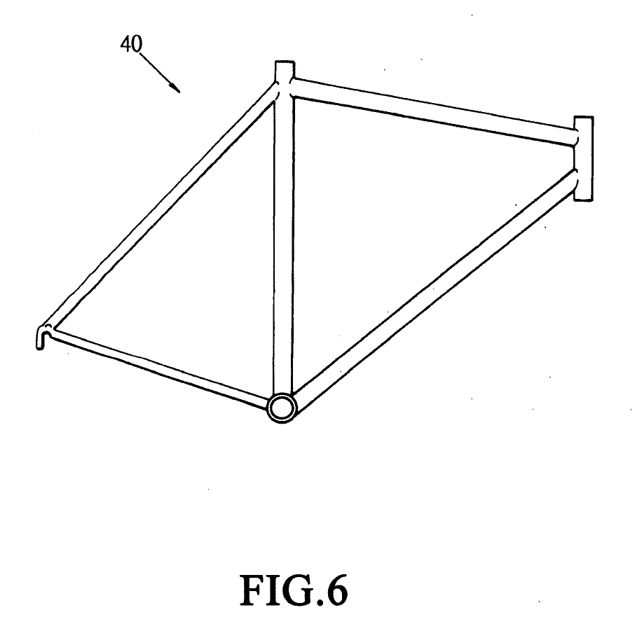

It is appreciated that the tube seat 20 according to the present invention is integrally made with titanium alloy and the frame of a bicycle is formed with the branch tubes of the tube seat 20 being welded to the metal tube 30 respectively as shown in FIG. 6. The frame 40 fabricated with tube seat according to the present invention has the following advantages:

1. It is easy to work: The tube seat 20 and the branch tubes 21 are integrally made as a single unit and the branch tubes 21 are butt-welded with the metal tube 30 respectively by the arc welding such that the frame 40 has been formed with the inclination of the respective branch tube 21 being preset beforehand to simplify the metal tube being disposed accurately.

2. It provides high structural strength: The outer end of the respective branch tube 21 is disposed with a stuffing ring to fill with the recesses at the joint between the respective branch tube 21 and the metal tube 30 during being worked with the arc welding such that a smooth surface can be obtained at the weld seam. In addition, the tube seat 20 and the branch tubes 21 are made integrally as a single unit with a higher strength than they are attached to each other with welding afterward.

3. It has a good looking appearance: Due to the branch tubes 21 of the tube seat 20 being butt-welded to the metal tube 30 respectively with the weld seam being between the respective branch tube 21 and the metal tube 30, it is convenient to grind and finish the weld seam manually or automatically for the weld seam becoming invisible.

4. It is capable of being detected with the nondestructive test easily: Because the preceding weld seam is perfectly formed, it is very fast and sensitive to be detected with the X-ray test for obtaining the structural strength and the material properties of the finished frame 40. Hence, the result such as the behavior of being subjected to a force and the durability can be realized easily.

Furthermore, the tube seat 20 and the metal tube 30, which are made of titanium alloy, being butt-joined to each other with the arc welding enables the idle gas masking much easily. As a result, a higher quality of welding can be obtained substantively under the condition of titanium and/or titanium alloy in association with the frame of the bicycle.

While the invention has been described with referencing to a preferred embodiment thereof, it is to be understood that modifications or variations may be easily made without departing from the spirit of this invention, which is defined by the appended claims.

What is claimed is:

1. A tube seat, which is made of titanium alloy for fabricating a frame of a bicycle, comprising:
a main tube; and
at least a branch tube extending outward from said main tube;
wherein, said branch tube is arc-welded with a metal tube made of titanium alloy firmly.

2. The tube seat according to claim 1, wherein an outer end of said branch tube radially projecting outward a stuffing ring to fill with a molten recess, which results from said branch tube butt-joining with said metal tube, between said branch tube and said metal tube for obtaining a smooth weld seam.

3. The tube seat according to claim 1, wherein the tube seat is fabricated as an upper tube seat, a five-way tube seat, a head tube seat, a hook tube seat, a crank arm seat, and a fork seat; said metal tube is fabricated as seat tube, a top tube, a seat stay, a down tube, a chain stay, a crank arm, and a fork for forming said frame.
